(19) United States
(12) Patent Application Publication
(10) Pub. No.: US 2012/0064358 A1
(43) Pub. Date: Mar. 15, 2012

(54) SLIDE MEMBER

(75) Inventors: Satoshi TAKAYANAGI, Inuyama-shi (JP); Yi ZHANG, Inuyama-shi (JP); Hiroyuki ASAKURA, Inuyama-shi (JP); Yukihiko KAGOHARA, Inuyama-shi (JP)

(73) Assignee: DAIDO METAL COMPANY LTD., Nagoya-shi (JP)

(21) Appl. No.: 13/233,259

(22) Filed: Sep. 15, 2011

(30) Foreign Application Priority Data
Sep. 15, 2010 (JP) 2010-206672

(51) Int. Cl. B32B 15/02; B32B 15/01

(52) U.S. Cl. 428/553; 428/647

(57) ABSTRACT

A slide member is disclosed. The slide member includes a Cu-based bearing alloy layer; an intermediate layer provided over the Cu-based bearing alloy layer; and a Sn-based overlay provided over the intermediate layer. The intermediate layer consists of one or more materials selected from a group of Ni, Ni alloy, Co, and Co alloy and is thinner than 4 μm. The Sn-based overlay contains Sn and 6 mass % or more of Cu.

### CROSS-REFERENCE TO RELATED APPLICATION(S)

This application is based upon and claims the benefit of priority from the prior Japanese Patent Application No. 2010-206672, filed on, Sep. 15, 2010 the entire contents of which are incorporated herein by reference.

### FIELD

The present invention relates to a slide member provided with a Sn-based overlay formed over a Cu-based bearing alloy layer through an intermediate layer.

### BACKGROUND

A slide member comprising a Cu-based bearing alloy layer having a metal backing is typically used as a slide bearing for internal combustion engines of automobiles. The Cu-based bearing alloy layer may be further coated with a Sn-based overlay for improvement of bearing properties such as conformability and embeddability. The Sn-based overlay may be doped with Cu to strengthen the Sn matrix and to prevent diffusion of Sn within the overlay toward the Cu-based bearing alloy layer.

Another approach to prevent Sn within the Sn-based overlay from diffusing toward the Cu-based bearing alloy layer is disclosed, for instance, in JP 2007-501898 A. JP 2007-501898 A employs an intermediate layer made of Ni which serves as a barrier against the Sn diffusion toward the Cu-based bearing alloy layer.

As disclosed in JP 2007-501898 A, Ni within the intermediate layer may form a Sn—Ni compound with Sn contained in the Sn-based overlay, or a Sn—Cu—Ni compound with a Sn—Cu alloy if the Sn-based overlay is doped with Cu. Because the compounds consume Ni, the intermediate layer loses some of its original Ni content, possibly leading to degradation of its diffusion barrier capacity. As a result, Sn within the Sn-based overlay may easily travel through the intermediate layer and into the Cu-based bearing alloy layer to produce brittle compounds such as Cu₃Sn with Cu, thereby degrading the anti-fatigue property of the slide member.

According to JP 2007-501898 A, thicker Ni-based intermediate layer was found to be effective in maintaining its diffusion barrier capacity for a relatively longer time period. However, because Ni has large internal stress, the slide member becomes increasingly brittle as the Ni-based intermediate layer becomes thicker, which in turn degrades the anti-fatigue properties of the slide member. Thus, thicker Ni-based intermediate layer is not effective in obtaining a slide member with outstanding anti-fatigue properties.

### SUMMARY

One object of the present invention is to provide a slide member having long lasting outstanding anti-fatigue properties.

Slide member according to one embodiment of the present invention includes a Cu-based bearing alloy layer; an intermediate layer provided over the Cu-based bearing alloy layer; and a Sn-based overlay provided over the intermediate layer. The intermediate layer consists of one or more materials selected from a group of Ni, Ni alloy, Co, and Co alloy and is thinner than 4 μm. The Sn-based overlay contains Sn and 6 mass % or more of Cu.

The Cu-based bearing alloy layer is made of Cu or Cu alloy containing non-Cu elements. Examples of such Cu alloy include Cu—Sn alloy, Cu—Sn—Bi alloy, and CU—Sn—Pb alloy.

The Cu-based bearing alloy layer may be provided over a backing made of metal such as iron.

The Cu-based bearing alloy layer has an intermediate layer and a Sn-based overlay formed over it in the listed sequence to form a laminate.

The intermediate layer serves as a bonding layer to facilitate the bonding of the Cu-based bearing alloy layer and the Sn-based overlay. The intermediate layer also serves as a diffusion barrier layer that prevents diffusion of Sn within the Sn-based overlay into the Cu-based bearing alloy layer. The intermediate layer may consist of any one of Ni, Ni alloy, Co, and Co alloy. Alternatively, the intermediate layer may consist of any two types of materials selected from Ni, Ni alloy, Co, and Co alloy. Examples of Ni alloy include Ni—Cr alloy, Ni—Fe alloy, and Ni—Co alloy. Examples of Co alloy include Co—Cr alloy, Co—Fe alloy, and Co—Ni alloy. Ni alloy, Co, and Co alloy are similar to Ni in terms of operation and effect.

The intermediate layer may be a laminate. In such case, each layer consists of any one of Ni, Ni alloy, Co, and Co alloy. The laminate of intermediate layer is preferably a double layer including a bottom layer consisting of Co or Co alloy located over the Cu-based bearing alloy layer, and a top layer consisting of Ni or Ni alloy located below the Sn-based overlay. The above described double layer is advantageous in that it prevents formation of a brittle intermetallic compound. For instance, assuming an intermediate layer consisting of a single layer of Ni located above a Cu-based bearing alloy layer containing Bi or Bi compound, a brittle intermetallic compound may result from unwanted bonding of Bi and Ni in the absence of a diffusion barrier. By providing a layer consisting of Co or Co alloy between the Cu-based bearing alloy layer and the layer consisting of Ni or Ni alloy, a barrier is created to prohibit the contact of Bi and Ni, thereby preventing formation of the brittle intermetallic compound.

The Sn-based overlay contains Cu in the Sn matrix and other elements as required.

Cu content within the Sn-based overlay strengthens the Sn matrix of the Sn-based overlay.

Cu within the Sn-based overlay exists within the Sn matrix in the form of a Cu—Sn compound. The inventors have found that a certain dose of Cu serves as a barrier to significantly reduce the diffusion of Sn within the Sn-based overlay into the intermediate layer, that is, the Cu-based bearing alloy layer. As a result, the unwanted bonding between Sn within the Sn-based overlay and the intermediate layer components (i.e. Ni, Ni alloy, Co, Co alloy) can be delayed, which in turn delays the speed of consumption of the original components within the intermediate layer by the bonding. Thus, according to one embodiment, the speed of Sn system compound formation within the intermediate layer is delayed to advantageously extend the life of the diffusion barrier feature of the intermediate layer.

Generally, when the intermediate layer is made of Ni or Ni alloy and the Sn-based overlay contains Cu—Sn compound, Sn and Cu—Sn compound within the Sn-based overlay form a Sn—Ni system compound and a Cu—Sn—Ni system compound with Ni or Ni alloy. Formation of Sn—Ni system compound and Cu—Sn—Ni system compound consumes Ni or Ni alloy originally contained in the intermediate layer and thus, reduces the Ni or Ni alloy content.

When the intermediate layer is made of Co or Co alloy and the Sn-based overlay contains Cu—Sn compound, Sn and Cu—Sn compound within the Sn-based overlay form Sn—Co system compound and Cu—Sn—Co system compound with Co or Co alloy. Formation of Sn—Co system compound and Cu—Sn—Co system compound consumes Co or Co alloy originally contained in the intermediate layer and thus, reduces the Co or Co alloy content.

The Sn-based overlay has Cu content of 6 mass % or more. The Sn-based overlay, when containing 6 mass % or more Cu, was found to exhibit outstanding diffusion barrier performance against Sn. Preferably, Cu content within the Sn-based overlay is 12 mass % or less. It has been found that 12 mass % or less Cu content within the Sn-based overlay adds toughness to the Sn-based overlay without becoming excessively hard to provide a good restraint to degradation of anti-fatigue property of the Sn-based overlay.

The intermediate layer is preferably less than 4 μm thick. When the intermediate layer is thinner than 4 μm, the components of the intermediate layer are subjected to little internal stress and thus, provide outstanding anti-fatigue property to consequently improve the anti-fatigue property of the slide member in which it is deployed.

The intermediate layer is preferably thicker than 3 μm. The intermediate layer, when thicker than 3 μm, increases Ni content within the slide member. Thus, relatively greater amount of components originally contained in the intermediate layer remain in their original form after the bonding of Sn of Sn-based overlay and the intermediate layer components to allow the diffusion barrier feature of the intermediate layer to remain effective for relatively longer time period.

In case the intermediate layer is made of multiple layers, the thickness of the laminate, that is, the intermediate layer in its entirety is preferably greater than 3 μm but less than 4 μm.

As described above, the slide member according to one embodiment of the present invention achieves improvement in anti-fatigue properties of the intermediate layer by thinning the intermediate layer. The thinning of the intermediate layer normally leads to the degradation of anti-fatigue properties by the diffusion of Sn within the Sn-based overlay to the Cu-based bearing alloy layer. However, the diffusion of Sn is suppressed by optimally controlling the concentration of Cu within the Sn-based overlay. Thus, anti-fatigue properties of the entire slide member is improved through coordinated efforts in improvement of anti-fatigue properties in the intermediate layer as well as in the Sn-based overlay.

The cross section of the intermediate layer is typically observed by observation instruments such as FIB-SIM (Focus Ion Beam Scanning Image Microscope), SEM (Scanning Electron Microscope), and TEM (Transmission Electron Microscope) at a preferable magnification of 5000× and an observation field of 20 μm×25 μm. The thickness of the intermediate layer is given by the maximum thickness measured within the observation field of an observation instrument exemplified above.

Through experiments based on samples of a slide member composed of a Cu-based bearing alloy layer, an intermediate layer provided over the Cu-based bearing alloy layer, and a Sn-based overlay provided over the intermediate layer, the inventors have verified the relation between the diffusion speed of Sn atoms within the Sn-based overlay to the Cu-based bearing alloy layer and the shapes of the particles of intermediate layer components.

The inventors have extracted the following features from the experiments.

The slide member according to one embodiment is provided with an intermediate layer comprising cubic crystalline particles and columnar crystalline particles, in which the number of columnar crystalline particles is greater than the number of cubic crystalline particles.

Components of intermediate layer (i.e. Ni/Ni alloy and Co/Co alloy) exist in the form of “cubic crystalline particles” and “columnar crystalline particles” which are described in detail hereinafter based on FIGS. 2A and 2B. FIGS. 2A and 2B are cross sectional views of the intermediate layer taken along the thickness direction and illustrate the component particles of the intermediate layer. The thickness direction indicates the direction in which the layers of the slide member are stacked as viewed in FIG. 1. The “component particles of the intermediate layer” refers to Ni particles, Ni alloy particles, Co particles and Co alloy particles.

“Cubic crystalline particle” shown in FIG. 2A is defined as a component particle of the intermediate layer that has an aspect ratio less than 2.5. Aspect ratio is given by length X divided by length Y where X is the length taken along the major axis of a component particle of the intermediate layer, whereas Y is the length taken along the minor axis of the component particle of the intermediate layer. “Columnar crystalline particle” shown in FIG. 2B, on the other hand, is a component particle of the intermediate layer that has an aspect ratio of 2.5 or greater.

The “major axis” is an imaginary straight line running through two points taken on the perimeter of the component particle of the intermediate layer that is most distant from one another. The “minor axis” is an imaginary straight line running perpendicularly across the center of the major axis. The major axis and the minor axis are given by measurements of the component particles of the intermediate layer taken within the observation field of the above described observation instruments.

Greater number of the columnar crystalline particles relative to the cubic crystalline particles in the intermediate layer observed within the observation field increases the possibility of columnar crystalline particles residing within the intermediate layer such that their longer sides are lined with the thickness direction of the intermediate layer. In such case, relatively less number of particle boundaries is observed in the thickness direction of the intermediate layer. A particle boundary running transverse to the thickness direction serves as a transport barrier to prevent Sn atoms having transported into the intermediate layer from the Sn-based alloy layer from further transporting in the thickness direction of the intermediate layer. This means that greater number of particle boundaries running transverse to the thickness direction, existing in the thickness direction within the intermediate layer, provides greater number of diffusion barriers within the intermediate layer and thus, delays the transport of Sn atoms within the Sn-based overlay to the Cu-based bearing alloy layer.

In one embodiment of the present invention, the number of cubic crystalline particles observed within the observation field of the intermediate layer is increased relative to the number of columnar crystalline particles, thereby increasing the number of particle boundaries of the component particles existing within the thickness direction of the intermediate layer. Thus, the diffusion speed of Sn atoms into the intermediate layer according to one embodiment of the present invention becomes relatively slower than the diffusion speed of Sn atoms into the intermediate layer in which the number of columnar crystalline particles is greater. Thus, according to one embodiment of the present invention, formation of brittle intermetallic compounds such as Cu₃Sn from Sn in Sn-based overlay and Cu in the Cu-based bearing alloy layer can be prevented to provide a slide member having outstanding and longer lasting anti-fatigue properties.

In one embodiment of the present invention, the intermediate layer is formed by electroplating. Electroplating is carried out in a Ni/Co plating bath of sulfamic acid which encourages the component particles of the intermediate layer to exist as a cubic crystalline particle. Adjustments can be made in the percentage of cubic crystalline particles, given by the relative number of cubic crystalline particles to columnar crystalline particles by varying the parameters of electroplating such as current density, bath temperature, and agitation strength. Ni/Co plating bath for forming the intermediate layer generally employs Watts bath and thus, tends to form columnar crystalline particles.

### BRIEF DESCRIPTION OF THE DRAWINGS

FIG. 1 is a cross sectional view of a slide member according to one embodiment of the present invention;

FIGS. 2A and 2B are descriptive views for explaining the concept of the aspect ratio measured for a component particle of an intermediate layer, where FIG. 2A represents a cubic crystalline particle and FIG. 2B represents a columnar crystalline particle;

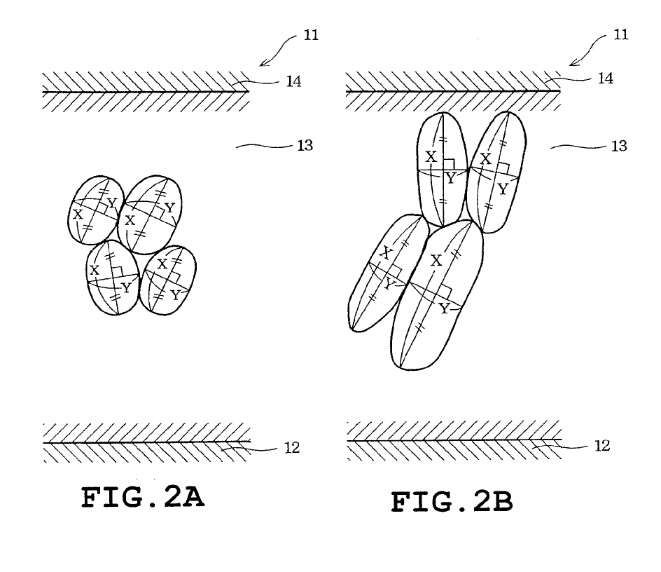

FIG. 3 is a chart indicating the results of the experiment; and

FIG. 4 is a chart indicating the conditions applied to the anti-fatigue test.

### DESCRIPTION

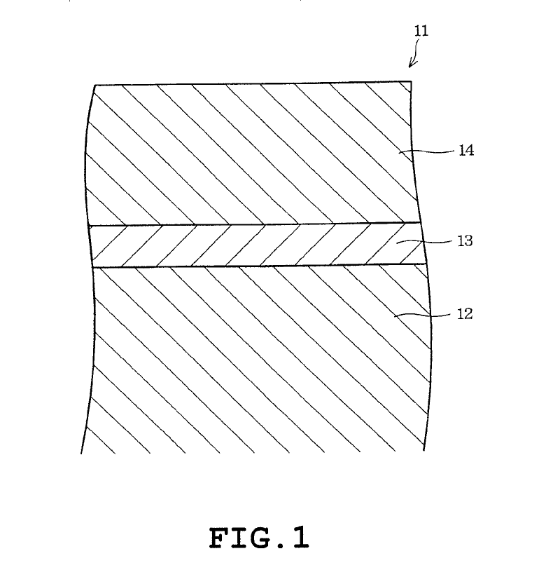

Slide member according to one embodiment of the present invention is illustrated in FIG. 1. Referring to FIG. 1, slide member 11 is composed of Cu-based bearing alloy layer 12 provided over a metal backing not shown, intermediate layer 13 provided over Cu-based bearing alloy layer 12 and Sn-based overlay 14 provided over intermediate layer 13.

Next, a description will be given on the advantages of the improved anti-fatigue property of slide member 11 according to one embodiment of the present invention.

The description begins with an explanation on how the samples used in the experiment were prepared. Samples identified as EXAMPLES 1 to 12 and COMPARATIVE EXAMPLES 1 to 8 were prepared so as to be similar in structure to slide member 11.

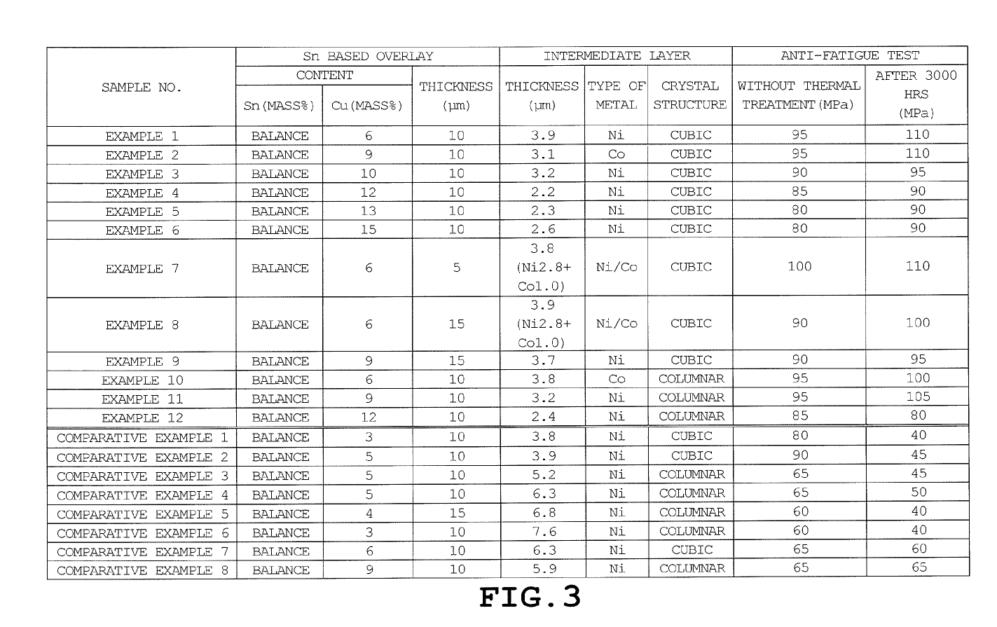

The preparation of the samples begins with coating a powdered Cu-based bearing alloy over a metal backing typically made of iron. The coated back metal layer was thereafter sintered and rolled to form the Cu-based bearing alloy layer over the back metal layer. The back metal layer and the Cu-based bearing alloy layer taken together constitute a bimetal. The bimetal was thereafter pressed to obtain a half bearing. Then, over the inner peripheral surface of the half bearing, in other words, over the Cu-based bearing alloy layer, an intermediate layer having compositions indicated in FIG. 3 were formed by electroplating. The surface of the intermediate layer was further electroplated to obtain a Sn-based overlay having compositions indicated in FIG. 3. The samples listed in FIG. 3 were prepared as described above.

To elaborate on the formation of the intermediate layer, Ni intermediate layer of EXAMPLES 1 and 3 to 9, and COMPARATIVE EXAMPLES 1, 2, and 7 were formed in a sulfamic acid bath containing nickel chloride, boric acid, and nickel sulfamate. Co intermediate layer of EXAMPLES 2, 7, and 8 were formed in a sulfamic acid bath containing cobalt chloride, boric acid, and sulfamate cobalt. Co intermediate layer of EXAMPLE 10 was formed in Watts bath containing cobalt chloride and boric acid. Ni intermediate layer of EXAMPLES 11, 12 and COMPARATIVE EXAMPLES 3 to 6, and 8 were formed in Watts bath containing nickel chloride and boric acid.

EXAMPLES 7 and 8 were obtained by: forming the Co intermediate layer over the Cu-based bearing alloy layer overlying the inner peripheral surface of the half bearing, forming Ni intermediate layer over the Co intermediate layer, and forming the Sn-based overlay over the Ni intermediate layer.

The Sn-based overlay was formed by a readily available organic sulfonic acid.

Adjustments were made in the thickness of the intermediate layer and the Sn-based overlay of the samples by varying the duration of electroplating. For instance, the intermediate layer of EXAMPLE 1 was electroplated for 6 minutes whereas the intermediate layer of EXAMPLE 6 was electroplated for 4 minutes. Likewise, the Sn-based overlay of EXAMPLE 1 was electroplated for 7 minutes whereas EXAMPLE 7 was electroplated for 3.5 minutes.

Referring to FIG. 3, the categorization of “CUBIC” or “COLUMNAR” under the “STRUCTURE” column of the intermediate layer was made as follows. First, the above described observation instruments where used to observe the sample obtained as described above. Every component particle of the intermediate layer within the 20 μm×25 μm observation field was measured for its major axis and minor axis to obtain the average aspect ratio within the observation field. In case the average aspect ratio is less than 2.5, the intermediate layer is deemed to be primarily configured by cubic crystalline particles and is indicated as “CUBIC” in FIG. 3. In case the average aspect ratio is 2.5 or greater, the intermediate layer is deemed to be primarily configured by columnar crystalline particles and is indicated as “COLUMNAR” in FIG. 3. Stated differently, a sample that is categorized as “CUBIC” in FIG. 3 has an intermediate layer that has half or more of its component particles occupied by cubic crystalline particles, meaning that the remaining other half or less are occupied by columnar crystalline particles. On the other hand, a sample that is categorized as “COLUMNAR” in FIG. 3 has an intermediate layer that has half or more of its component particles occupied by columnar crystalline particles, meaning that the remaining other half or less are occupied by cubic crystalline particles.

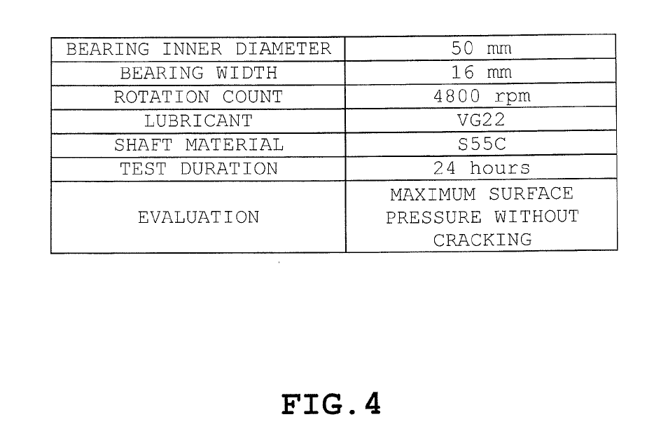

The samples thus obtained were tested for their anti-fatigue properties under the conditions indicated in FIG. 4. Some of the samples where tested under the same conditions after being thermally treated for a certain time period to verify the impact of diffusion of Sn within the Sn-based overlay on anti-fatigue properties. FIG. 3 indicates the test results for the samples which were not thermally treated under the column “WITHOUT THERMAL TREATMENT”, as well as the test results for the samples which were thermally treated at 130 degrees Celsius for 3000 hours under the column “AFTER 3000 HRS”. As will be later discussed in more detail, Sn in the Sn-based overlay becomes more susceptible to diffusing into the intermediate layer, in this case, the Cu-based bearing alloy layer in heated samples.

Below is an analysis of the anti-fatigue test results.

Comparison of EXAMPLES 1 to 12 with COMPARATIVE EXAMPLES 1 to 8 shows that EXAMPLES 1 to 12 have excellent anti-fatigue properties with or without thermal treatment because the intermediate layer is thinner than 4 μm and contains 6 mass % or more Cu within the Sn-based overlay. Further, the observations of the cross sections of the thermally treated samples revealed that the intermediate layer of EXAMPLES 1 to 12 had Ni or Co remaining in the form as originally present, whereas the intermediate layer of COMPARATIVE EXAMPLES 1 to 3 did not have any Ni or Co remaining in the form as originally present. COMPARATIVE EXAMPLES 4 to 8 shows inferior anti-fatigue properties with or without thermal treatment because of the thick intermediate layer.

It can be further understood by comparing EXAMPLES 1 to 9 that EXAMPLES 1 to 3 as well as 7 to 9 exhibit outstanding anti-seizure properties even after thermal treatment since the intermediate layer is thicker than 3 μm.

Still further, comparison of EXAMPLES 1 to 4 with 10 to 12 shows that EXAMPLES 1 to 4 have outstanding anti-seizure properties even after thermal treatment because the structure of intermediate layer is “CUBIC”.

Though not shown, experiments based on EXAMPLES 1 to 12 having an intermediate layer containing Ni alloy/Co alloy instead of Ni/Co exhibited substantially the same anti-fatigue properties to those of Ni intermediate layer.

The above described embodiment may be modified as required as follows.

The Cu-based bearing alloy layer, the intermediate layer, the Sn-based overlay, and the metal backing may contain unavoidable impurities. Further, each of the above described layers may contain hard particles such as oxides and carbides as well as solid lubricants such as sulfides and graphite.

The foregoing description and drawings are merely illustrative of the principles of the present invention and are not to be construed in a limited sense. Various changes and modifications will become apparent to those of ordinary skill in the art. All such changes and modifications are seen to fall within the scope of the invention as defined by the appended claims.

What is claimed is:

1. A slide member comprising:
a Cu-based bearing alloy layer;
an intermediate layer provided over the Cu-based bearing alloy layer; and
a Sn-based overlay provided over the intermediate layer;
wherein the intermediate layer consists of one or more materials selected from a group of Ni, Ni alloy, Co, and Co alloy and is thinner than 4 μm; and
wherein the Sn-based overlay contains Sn and 6 mass % or more of Cu.

2. The slide member according to claim 1, wherein Cu content in the Sn-based overlay is 12 mass % or less.

3. The slide member according to claim 1, wherein the intermediate layer is thicker than 3 μm.

4. The slide member according to claim 2, wherein the intermediate layer is thicker than 3 μm.

5. The slide member according to claim 1, wherein the intermediate layer consists of cubic crystalline particles and columnar crystalline particles, and the intermediate layer includes greater number of the cubic crystalline particles as compared to the columnar crystalline particles within an observation field.

6. The slide member according to claim 2, wherein the intermediate layer consists of cubic crystalline particles and columnar crystalline particles, and the intermediate layer includes greater number of the cubic crystalline particles as compared to the columnar crystalline particles within an observation field.

7. The slide member according to claim 3, wherein the intermediate layer consists of cubic crystalline particles and columnar crystalline particles, and the intermediate layer includes greater number of the cubic crystalline particles as compared to the columnar crystalline particles within an observation field.

8. The slide member according to claim 1, wherein the intermediate layer is a laminate including an uppermost layer consisting of Ni or Ni alloy and a lowermost layer consisting of Co or Co alloy.

9. The slide member according to claim 4, wherein the intermediate layer is a laminate including an uppermost layer consisting of Ni or Ni alloy and a lowermost layer consisting of Co or Co alloy.
